(19) United States
(12) Patent Application Publication
(10) Pub. No.: US 2015/0185909 A1
(43) Pub. Date: Jul. 2, 2015

(54) METHOD OF SENSING A USER INPUT TO A CAPACITIVE TOUCH SENSOR, A CAPACITIVE TOUCH SENSOR CONTROLLER, AN INPUT DEVICE AND AN APPARATUS

(71) Applicant: Libor Gecnuk, Prostejov (CZ)

(72) Inventor: Libor Gecnuk, Prostejov (CZ)

(73) Assignee: Freescale Semiconductor, Inc., Austin, TX (US)

(21) Appl. No.: 14/406,960

(22) PCT Filed: Jul. 6, 2012
(86) PCT No.: PCT/IB2012/053473

§ 371 Date: Dec. 10, 2014

(51) Int. Cl. G06F 3/044

(52) U.S. Cl. CPC G06F 3/044

(57) ABSTRACT

A method of sensing a user input to a capacitive touch sensor having a sense electrode is described. The method comprises obtaining a measure of capacitance of the sense electrode of the capacitive touch sensor, determining an indication of contact between a finger of a user and the capacitive touch sensor from comparing the measure of capacitance to a first threshold and determining an indication of exceeding a minimum pressure exercised by the finger of the user on the capacitive touch sensor from comparing the measure of capacitance to a second threshold, the second threshold being different from the first threshold. A capacitive touch sensor controller being arranged to perform such method is described. An input device for receiving user input is described. The input device comprises a capacitive touch sensor and such capacitive touch sensor controller.

### FIELD OF THE INVENTION

This invention relates to a method of sensing a user input to a capacitive touch sensor, a capacitive touch sensor controller, an input device and an apparatus.

### BACKGROUND OF THE INVENTION

Capacitive touch input is used in a variety of systems to allow a user to input information or instructions to a system. Herein, a capacitance of a capacitive electrode may be measured and compared to a threshold value to estimate whether a user's finger touches a touch sensor's surface to detect a touch from the influence of the user's finger on the capacitance when in a proximity of the capacitive electrode. As an example, a control panel of e.g. a control unit of an elevator may have a capacitive touch sensitive display having a plurality of areas allowing a user to control the elevator to go to a required floor by touching an associated area on the touch sensitive display and detecting such touch as a user input. However, while approaching the wanted area, the user may accidentally have come so close to a neighbouring area that capacitance measurement of the neighbouring area exceeded the threshold value, resulting in a wrong input. As another example, a pin entry device may have a capacitive touch sensitive key pad allowing a user to input enter a personal identification (PIN) code to provide an authorized user action, such as, e.g., allow access to a building with an alarm system, cash withdrawal from the user's bank account with an automatic teller machine (ATM) or a payment deducted from the user's bank account in a point of sales (POS) terminal. Some of these systems, e.g., some point of sales terminals, may be operable unattended, such as an unstaffed petrol station, or a ticket vendor machine. In such pin entry devices, the different keys are usually arranged relatively close together for, e.g., security reasons, such that an accurate, eye controlled movement of the user's finger is needed to prevent entering wrong entries by accidentally coming too close to another key than the intended key. Another drawback of some known pin entry devices may be that a non-authorized person may use the pin entry device if the non-authorized person knows the pin code. The non-authorized person may e.g. have obtained the pin code from watching the authorized person entering the pin code on the pin entry device. Known pin entry devices therefor generally have a shield which aims to limit the visibility of the key pad to the user and prevent others from viewing which keys of the key pad are used to enter the PIN code. Such shield thus aims to deter the visual observation of PIN values as they are being entered. However, a careful observation by the non-authorized person of the gestures of the authorized user, corresponding to the movements of his finger towards and away from the key pad for entering subsequent entries of his pin code, may still allow the non-authorized person to reconstruct which PIN code that the authorized user has entered on the touch sensitive key pad.

### SUMMARY OF THE INVENTION

The present invention provides a method of sensing a user input to a capacitive touch sensor, a capacitive touch sensor controller, an input device and an apparatus as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale.

FIG. 1 schematically shows an example of an embodiment of an input device;

FIG. 2 schematically shows an example of a method;

FIG. 3 and FIG. 4 schematically indicate a user input action;

FIG. 5 schematically shows a detail of an example of a further embodiment;

FIG. 6 schematically shows a detail of an example of another further embodiment;

FIG. 7 schematically shows an example of another embodiment of an input device;

FIG. 8 schematically shows an example of an apparatus;

FIG. 9 and FIG. 10 schematically shows an example of front views of exemplary input devices.

### DETAILED DESCRIPTION OF THE PREFERRED EMBODIMENTS

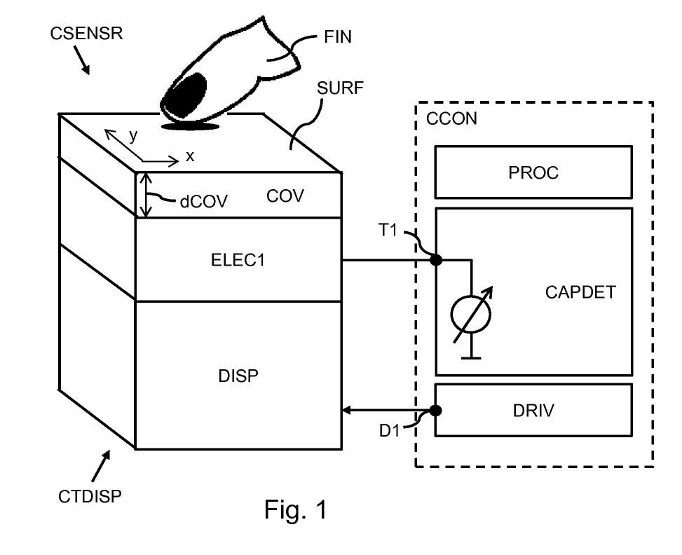

FIG. 1 schematically shows an example of an embodiment of an input device 100. The input device 100 has a capacitive touch screen CTDISP and a capacitive touch sensor controller COON.

The capacitive touch screen CTDISP comprises a capacitive touch sensor CSENSR and an electronic display DISP. The electronic display DISP is viewable by the user through the capacitive touch sensor CSENSR. The capacitive touch sensor CSENSR has a sense electrode ELEC1 and a dielectric cover layer COV. The sense electrode ELEC1 and the dielectric cover layer COV are at least partly transparent for visible light. The capacitive touch sensor CSENSR has an external front surface SURF that is touchable by a finger FIN of a user. The capacitive touch sensor CSENSR may be a position-sensitive sensor allowing to estimate a position on the front surface SURF with approximate x and y positions, as indicated with the xy arrows. The dielectic cover COV may, for example, be a glass plate. The dielectric cover COV has a thickness dCOV which may e.g. in a range of 0.5-2 mm for a capacitive touch screen for consumer use, or, e.g., in a range of 5-40 mm for a capacitive touch screen for use in a tamper resistant environment such as in an ATM.

The capacitive touch sensor controller COON comprises a capacitance detector CAPDET, a sense terminal T1, a display driver DRIV, a display drive terminal D1 and a processor PROC. The processor PROC is connected to the capacitance detector CAPDET and the display driver DRIV, and arranged to control the capacitance detector CAPDET and the display driver DRIV. The capacitance detector CAPDET of the capacitive touch sensor controller COON is electrically connected to the sense electrode of the capacitive touch sensor CSENSR via the sense terminal T1. The capacitance detector CAPDET is arranged to obtain a measure of capacitance of the sense electrode of the capacitive touch sensor CSENSR via the sense terminal T1 and to provide the measure to the processor PROC. The measure of capacitance may hereby be provided as a capacitance signal to sense terminal T1. Methods to determine a measure of capacitance are known in the art, such as using e.g. a charge-discharge method with charge-to-voltage, charge-to-time or charge-to-frequency conversion, and will thus not be described here in further detail. The display driver DRIV is electrically connected to the electronic display DISP via the display drive terminal D1. The display driver DRIV is arranged to, under control of the processor PROC, drive the electronic display DISP to display visual information.

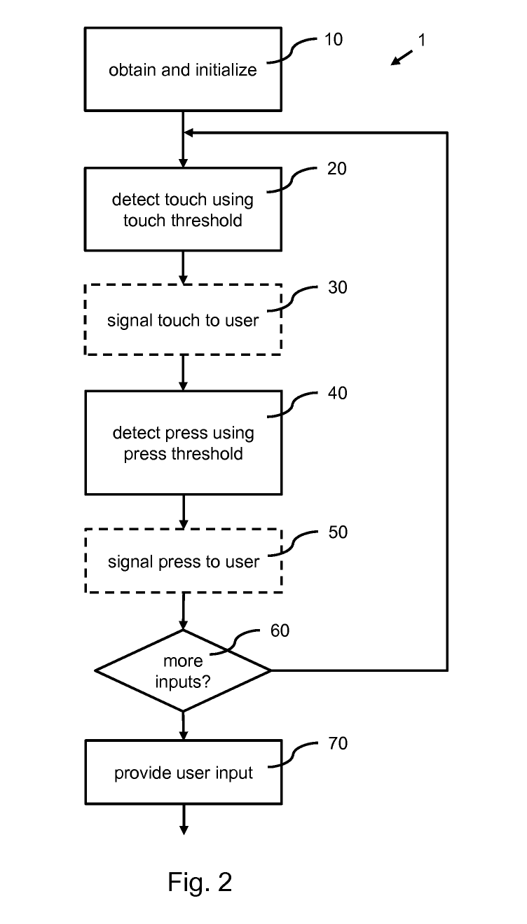

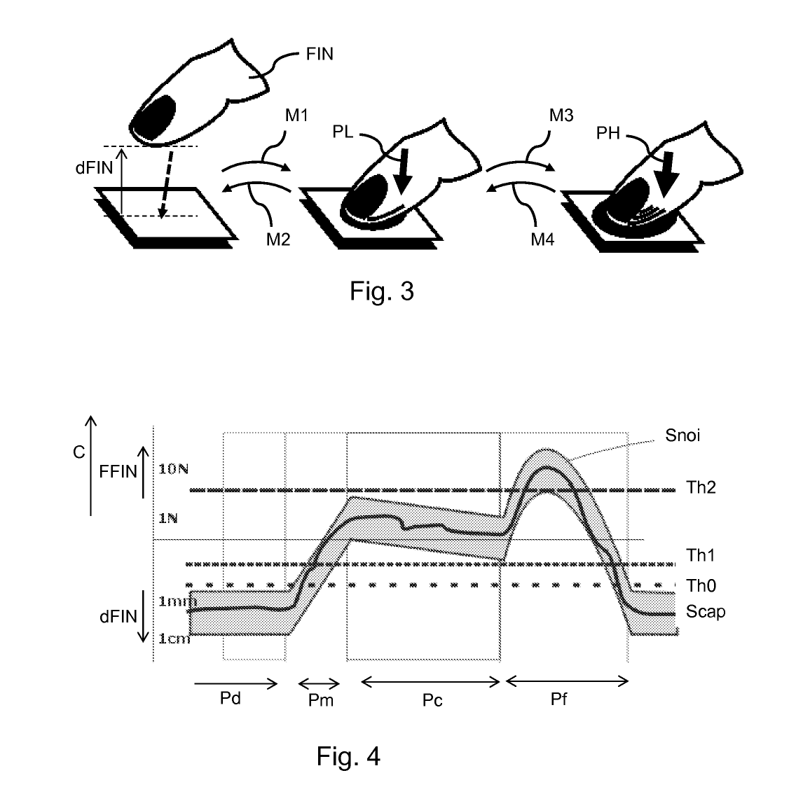

The capacitive touch sensor controller COON is arranged to perform a method of sensing a user input. An example of such method is described with reference to FIG. 2, FIG. 3 and FIG. 4. FIG. 3 schematically shows three phases of a possible user input action. FIG. 4 schematically shows a measure of capacitance over time of a user input.

FIG. 2 shows a method 1 of sensing a user input to a capacitive touch sensor CSENSR having a sense electrode ELEC1. The method shown in FIG. 2 comprises, in a first action 10, initializing and obtaining a measure of capacitance of the sense electrode ELEC1 of the capacitive touch sensor CSENSR. The measure of capacitance may be obtained at pre-determined intervals, at dynamically controlled intervals, or substantially continuously. The method further comprises, in a next action, determining 20 an indication of contact between a finger of a user and the capacitive touch sensor from comparing the measure of capacitance to a first threshold. The first threshold may be a first pre-determined threshold value or may be dynamically controlled, for example in dependence on a baseline level. The first threshold may be set such that the indication of contact indicates ‘contact’ if the measure of capacitance is in a range which typically corresponds to a finger of a user being in contact with the external front surface SURF or at least in a near proximity thereof, whereas the indication indicates ‘no contact’ if the measure of capacitance is in a range which typically corresponds to the finger being at a far distance, e.g., at a distance of at least 1 cm. The skilled person will appreciate that a near proximity may be difficult to distinguish from a slight contact, as both situations may correspond to substantially the same capacitance.

The method may further comprise, as a next action, signalling 30 to the user that a contact is detected if the indication of the contact corresponds to the finger making contact. Hereby, the user may be informed that the contact of his finger has been detected and that a user input is expected.

The user may hereby be prompted to confirm the input that he wishes to enter. The signalling 30 may comprise highlighting a visual information on the electronic display DISP, to inform the user which input corresponds to the detected contact. Upon having been signalled, the user may firmly push on the front surface SURF and hereby increase the finger pressure on the surface if the user wishes to provide a user input.

The method further comprises, as a next action, determining 40 an indication of exceeding a minimum pressure exercised by the finger of the user on the capacitive touch sensor from comparing the measure of capacitance to a second threshold, the second threshold being different from the first threshold. The second threshold may correspond to a larger capacitance than the first threshold. The second threshold may be a second pre-determined threshold value or may be dynamically controlled, for example in dependence on a baseline level. The indication may thus correspond to a ‘press’ on the capacitive touch sensor if a significant finger pressure is exercised by the user to hereby indicate that a user input is detected, whereas the indication may correspond to a ‘no press’ if no or only a small finger pressure is exercised by the user to hereby indicate that no user input is detected. The risk that the user accidentally provides a user input by accidentally coming close to the capacitive touch sensor may hereby be reduced.

The method may further comprise, as a next action, signalling 50 to the user that a push is detected if the indication of the pressure corresponds to the pressure exceeding the minimum pressure. The user may hereby be given feedback on the receipt of the user input. The user may thereafter e.g. check whether the user input that he intended to give was indeed received, and he may take corrective action if he considers that appropriate, for example, give a corrected user input or cancel completely.

The method may further comprise, as a next action providing 70 the user input according to the indication of the pressure if the indication of the pressure corresponds to the pressure exceeding the minimum pressure. The user input may be provided to an apparatus as, for example, control information. The user input may be provided in a digital form, e.g. indicating that the touch sensor has been touched or not. E.g., the touch sensor may comprise a key pad area and the user input may indicate whether the key pad area has been pressed or not. The user input may be provided as comprising a degree of pressure if the indication of pressure indicates a degree of pressure.

The method may further comprise determining an indication of a degree of pressure exercised by the finger on the capacitive touch sensor from comparing the measure of capacitance to the first threshold, the second threshold and the at least one further threshold. Providing the user input according to the indication of the pressure may comprise providing the user input according to the indication of the degree of pressure. Hereby, the method may allow to discriminate between user inputs at different levels, e.g., proportional to the exercised pressure. The user may hereby, e.g., control a speed of movement of a cursor or speed of scrolling. Herein, visual, tactile, vibrating and/or other physilogical feedback of the mouse movement or scrolling may enable the user to exercise the appropriate pressure.

The method may further comprise selecting a signal processing mode from a plurality of signal processing modes in dependence on the comparison of the measure of capacitance to the first threshold and/or the comparison of the measure of capacitance to second first threshold. For example, a first signal processing mode may be selected for determining 20 the indication of contact between the finger and the capacitive touch sensor from comparing the measure of capacitance to the first threshold. If the indication of the contact corresponds to the finger making contact, a second processing mode may be selected for determining 40 the indication of exceeding a minimum pressure exercised by the finger on the capacitive touch sensor from comparing the measure of capacitance to the second threshold. The first and/or second processing mode may e.g. comprise a neurophysiologic signal processing as described in international patent application WO 2012/049535 A1 and/or US patent U.S. Pat. No. 6,597,945 B2 to support discriminating between human and non-human contact.

The first threshold Th1 may correspond to a first capacitance value and the second threshold Th2 may correspond to a second capacitance value. The second capacitance value may be at least two times larger or more. The optimal values for the first and second threshold may be established in dependence on e.g. dielectric layer thickness, size of the sense electrode, type and/or sensitivity of capacitance measurement, other design parameters of the capacitive touch sensor, environmental conditions and user-specific parameters.

For example, in an example sensor having a 1 mm dielectric thickness dCOV of a glass cover COV and a capacitive sense electrode of 10×10 mm², a capacitance of approximately 0.005 pF was measured when a finger was about dFIN=20 cm away from the external surface SURF as indicated in the left figure of FIG. 3; this capacitance may be referred to as distant capacitance. A capacitance in a range of 0.1-2.0 pF was measured when the finger was in a range of 5.0 mm to 0.0 mm of the external surface SURF (0 mm corresponding to just making contact with the surface, with a pressure PL being close to 0, e.g., corresponding to a force of 1 N) as indicated in the middle figure of FIG. 3; this capacitance may be referred to as contact capacitance. A capacitance in a range of 5.0-10.0 pF was measured when the finger was exercising a pressure PH corresponding to a force of 3-10 N on the external surface SURF as indicated in the right finger of FIG. 3; this capacitance may be referred to as press capacitance. Thus, a first threshold corresponding to a first capacitance value in a range of 0.02-0.1 pF may be used to discriminate between the finger being at a distance (left figure) and the finger being close to the external surface SURF or in contact therewith (middle figure). Movements between these two situations are indicated with arrows M1 and M2. A second threshold corresponding to a second capacitance value in a range of 2.5-5.0 pF may be used to discriminate between the finger being close to the external surface SURF or in contact therewith (middle figure) and the finger exercising a significant pressure (right figure). Movements between these latter two situations are indicated with arrows M3 and M4.

The method may further comprise determining a baseline level. In further embodiments, the method may comprise dynamically determining a baseline level. The baseline level may correspond to a baseline measure of capacitance. The baseline level may serve as a reference level for the first and/or second threshold. The baseline level may e.g. be determined from low-pass filtering the measure of capacitance. The baseline level may thus account for environmental influences and/or variations over longer periods, such as periods of several seconds, minutes, hours or even longer periods of time.

FIG. 4 shows an example of a capacitance measurement as a function of time during a user input action. In FIG. 4, time runs from left to right. Capacitance increases in the vertical direction as indicated with C along the left axis. An indication of pressure exercised by the finger is given with a force indication FFIN corresponding PL=1 N and PH=10 N. An indication of the distance dFIN between the finger and the external surface SURF is indicated for a distance of 1 mm and 1 cm. The measure of capacitance is indicated with graph Scap, including a noise band Snoi. A baseline level Th0, the first threshold Th1 and the second threshold Th2 are indicated. During a first period Pd, the finger FIN is at a few millimetres way from the external surface and the measure of capacitance is below the first threshold Th1. During a second period Pm, of about 20 ms long, the finger FIN is approaching the external surface SURF and the measure of capacitance increases beyond the first threshold Th1, after which the capacitive sensor controller COON controls the electronic display DISP to show an indication of touch to the user. During a third period Pc of about 100 ms long, the finger is in slight contact with the external surface and exercises a pressure between approximately 0 and approximately 1 N, until the user responds to the indication of touch as seen on the electronic display DISP. The user then, in the first half of a fourth period Pf, increases the force exercised by his finger on the external surface SURF, and thereby increases the pressure beyond the minimum pressure associated with the second threshold Th2. The electronic display DISP indicates that a user input is detected once the measure of capacitance increases beyond the second threshold Th2. As FIG. 4 shows, the user reacts to this indication about 10 ms late and then reduces the force again and releases its finger. The baseline level Th0 may serve as a reference level for the first threshold Th1 and the second threshold Th2. The baseline level may e.g. be determined from low-pass filtering the measure of capacitance Sca, e.g., corresponding to a running average of the level of the measure of capacitance Sca over a period in a range of 1 sec-1 min, such as 10 sec. Suitable methods of environment monitoring and/or bio-impedance signal processing, for example comprising one or more of the methods described in international patent application WO 2012/049535 A1 and/or US patent U.S. Pat. No. 6,597,945 B2, may be used to improve the determination of human finger touch or pressure during the third period Pc and/or the fourth period Pf. Determining 40 the indication of exceeding a minimum pressure may comprise processing the measure of capacitance using a neurophysiologic signal processing. For example, during the third period Pc, a neurophysiologic signal processing may be activated which is arranged to measure bio-electricity and/or bio-potentials of a neural system indirectly and noninvasively through capacitive electrode(s) and may so be used to electrically capture human decision phases of a touch, from a slight touch to one or more degrees of pressure PH, during this this period Pc. Hereby, the method may exploit that human touch may be a volitional process that is electriclly controlled by the central nervous system (CNS) and may, for example, be measured using the neurophysiologic signal processing to confirm true human touch. For example, human touch is known to be associated with a sequence of different typical phases which may start with a decision from the CNS, continue with one or more neuro-motoric action(s) to coordinate the finger movement towards a touch area on the external surface SURF, a neuro-tactile awaiting feedback, one or more neuro-motoric action(s) to stop finger movement and to control finger pressure on the touch area and finally a further decision of the CNS to take the finger off the touch area, following by one or more neuro-motoric action(s) to coordinate the finger movement away from the touch area. Combinations of capacitive measurement with multiple thresholds and with neurophysiologic signal processing may significantly reject malfunctions of capacitive touch systems in a harsh environment and/or may allow to differentiate between a true human touch and non-human contact, such as with an ability to recognize materials and structures.

The method may further comprise, after having determined the indication of exceeding the minimum pressure as the indication of the pressure corresponding to the pressure exceeding the minimum pressure, determining an indication of a sequence of a decrease of the pressure exercised by the finger followed by an increase of the pressure from comparing the measure of capacitance to a third second threshold to indicate the decrease and subsequently comparing the measure of capacitance to the second threshold to indicate the increase. The third threshold may be equal to the first threshold, the third threshold may be equal to the second threshold, or third threshold may be in between the first threshold and the second threshold. Hereby, a sequence of user inputs may be detected while the finger remains in contact or close to the external surface SURF. The visibility of subsequent user inputs to other persons may hereby be reduced, whereby the entering of the user inputs may remain more secure.

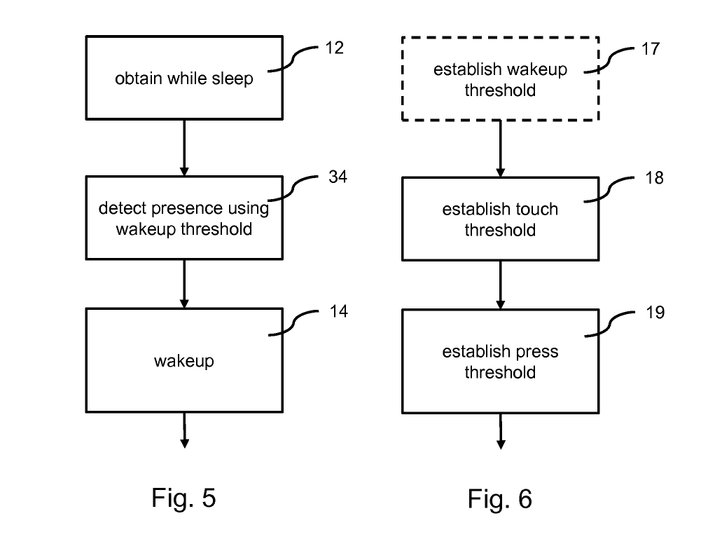

FIG. 5 schematically shows a detail of an exemplary method of a further embodiment. The method comprises obtaining 12 a measure of capacitance of the sense electrode while the capacitive touch sensor CSENSR, the electronic display DISP and the capacitive touch sensor controller COON are in a low-power mode, further referred to as the sleep mode. In the sloop mode, the electronic display DISP may operate at a low brightness and the capacitive touch sensor controller COON may operate at a reduced clock frequency and/or at a coarse accuracy. The method may comprise determining 13 an indication of a presence of the user at a distance from the capacitive touch sensor from comparing the measure of capacitance to a wakeup threshold, the wakeup threshold being different from the first threshold and the second threshold. The wakeup threshold may be established to detect the presence of a user in at a distance in a distance range of e.g. 5-50 cm, such as a distance range of 5-20 cm or 2-20 cm, from the front surface SURF. The method may further comprise waking up 14 the capacitive touch sensor CSENSR, the electronic display DISP and the capacitive touch sensor controller COON. The waking up 14 may comprise increasing the brightness of the electronic display DISP and operating the capacitive touch sensor controller COON, as well as other operational units, at a nominal clock frequency and/or full accuracy.

FIG. 6 schematically shows a detail of an example of a further embodiment. FIG. 6 shows that the method may comprise actions of establishing 17 the wakeup threshold, establishing 18 the first threshold and establishing 19 the second threshold. These actions may be executed as part of the initializing in the first action 10 and/or may be repeated subsequently.

Establishing 17 the wakeup threshold, establishing 18 the first threshold and establishing 19 the second threshold may comprise initializing the wakeup threshold and/or the first threshold and/or the second threshold with a pre-determined wakeup initialization value, a pre-determined first threshold initialization value first and/or a pre-determined second threshold initialization value. The method may use the threshold values as initialized as fixed threshold values during the further actions. The method may alternatively comprise dynamically controlling the wakeup threshold and/or the first threshold and/or the second threshold. The wakeup threshold and/or the first threshold and/or the second threshold may e.g. be dynamically controlled in dependence on a baseline level. Hereby, the method may for example adapt to environmental changes, e.g., humidity. The method may for example adapt to optimally respond to a user or the user's finger. For example, for a 1 mm dielectric distance and an electrode of 7×5 mm, a press capacitance may range from 2 pF from a dry woman finger to 6 pF for a wet man finger. Dynamically controlling the thresholds may be performed while obtaining a measure of the capacitance, e.g., at regular intervals, continuously, or upon a detection of a change of the measure of capacitance.

Dynamically controlling the wakeup threshold and/or the first threshold and/or the second threshold may be performed from applying a low-pass filter to the measure of the capacitance to obtain a low-pass signal and dynamically determining the wakeup threshold and/or the first threshold and/or the second threshold in dependence on at least the low-pass signal. The low-pass filter may e.g. correspond to determining a running average over a period in a range of 1-10 seconds or longer. The low-pass filter may e.g. use an Infinite Impulse Response (IIR) filter, a Finite Impulse Response Filter (FIR), a Gaussian filter. The low-pass filter may e.g. be implemented using a digital filter or using an analogue filter.

Dynamically controlling the first threshold and/or the second threshold may further comprise applying a peak-detection to the measure of the capacitance to obtain a peak signal and determining the first threshold and/or the second threshold in dependence on at least the peak signal.

Dynamically controlling the first threshold and/or the second threshold may comprise accounting for environmental influences as described in applicant's international patent application WO 2012/049535 A1, incorporated herein by reference.

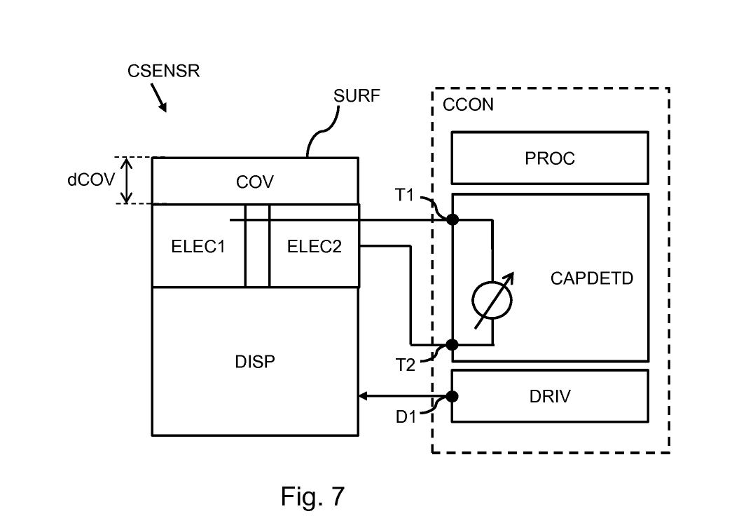

FIG. 7 schematically shows an example of another embodiment of an input device. The input device of FIG. 7 differs from that shown in FIG. 2 in that the sense electrode comprises a first electrode part ELEDC1 and a second electrode part ELEC2 arranged for a differential capacitance measurement and that the capacitance detector CAPDETD comprises a first terminal T1 and a second terminal T2. The capacitance detector CAPDETD is arranged to obtain 10 the measure of capacitance of the sense electrode of the capacitive touch sensor CSENSR using a differential capacitance measurement on the first electrode part ELEC1 and the second electrode part ELEC2. Hereby, environmental influences on the capacitance measurement may be reduced.

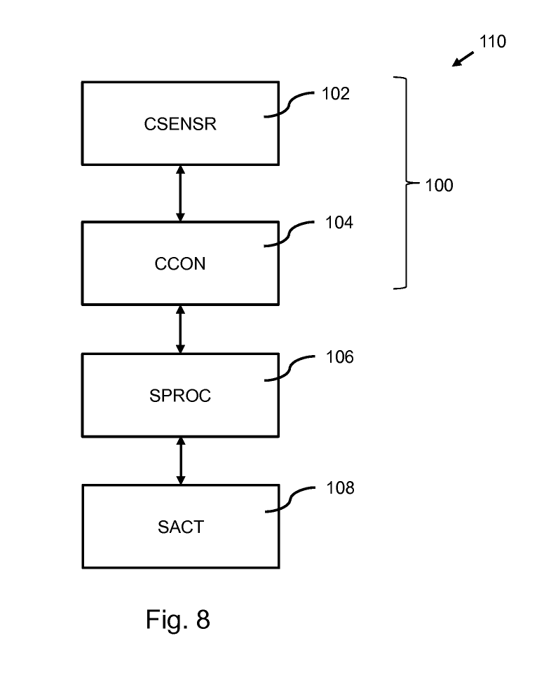

FIG. 8 schematically shows an example of an apparatus 110. The apparatus 110 has an input device 100 having a capacitive touch sensor CSENSR, also indicated with 102, a capacitive touch sensor controller COON, also indicated with 104, a system processor SPROC, also indicated with 106 and a system actuator SACT, also indicated with 108. The capacitive touch sensor controller COON is electrically connected to the sense electrode of the capacitive touch sensor CSENSR to obtain a measure of capacitance of the sense electrode of the capacitive touch sensor CSENSR, to determine a user input from the measure of capacitance, and to provide the user input to the system processor SPROC. The system processor SPROC is arranged to control the system actuator SACT in dependence on the user input.

The apparatus 110 may e.g. be a mobile phone having a capacitive touch screen, a security system with pin entry such as an ATM or access control system (security), or any other apparatus operated under user control such an elevator having an elevator control panel as capacitive touch sensor 102 and an elevator motor as system actuator SACT.

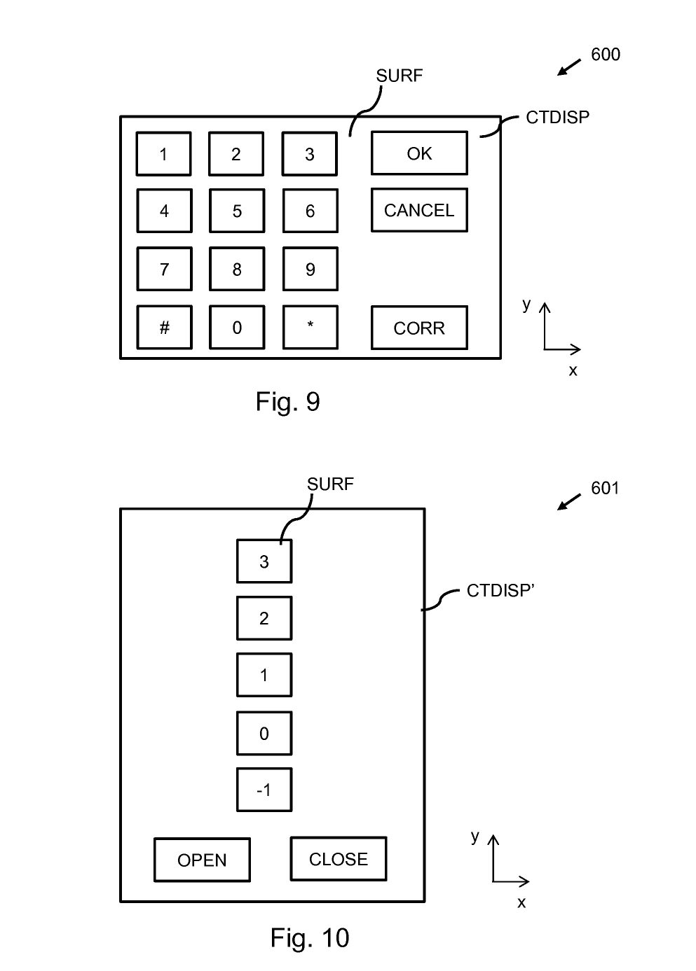

FIG. 9 schematically shows an example of a front view of an exemplary input device. The input device shown in FIG. 9 is a capacitive PIN pad for, for example, an ATM. Such capacitive PIN pad may be an example of an input device comprising a capacitive touch sensor CSENSR comprising a plurality of sense electrodes in a spatial configuration and the capacitive touch sensor controller COON being electrically connected to the plurality of sense electrodes of the capacitive touch sensor CSENSR to obtain a respective plurality of measures of capacitance of the plurality of sense electrodes of the capacitive touch sensor CSENSR. Hereby, positions of touch and press may be detected to discriminate between the different keys of the key pad.

As shown in FIG. 9, the capacitive PIN pad may comprise a touch screen 600. The touch screen 600 may comprise the capacitive touch sensor CSENSR and an electronic display CTDISP, wherein the electronic display CTDISP is viewable by the user through the capacitive touch sensor CSENSR. The electronic display CTDISP may hereby present a plurality of keys to the user, as indicated in FIG. 9 with numerical values ‘0’-‘9’ for inputting digits of the PIN code and further symbols ‘OK’, ‘CANCEL’ and ‘CORR’ as control inputs for confirmation, cancellation or correction of one or more entries.

When a user operates the capacitive PIN pad, he may first bring his finger FIN in close proximity to or in contact with the front surface SURF of the capacitive touch sensor CSENSR. The capacitive touch sensor controller COON may then signal such contact to the user by, for example, highlighting the displayed key that is closest to the point of contact of the finger. The user may then increase the finger pressure on the highlighted displayed key to input the associated value as a first entry, or, when the user wishes to press another key, move his finger to another position on the front surface SURF, corresponding to the key that the user wishes to press, and then increase the pressure to input the associated value as the first entry. The capacitive touch sensor controller COON may then signal such pressure to the user by, for example, showing a confirmation message. The user may then continue input further entries by to reduce the pressure, moving his finger to other positions corresponding to other keys moving while remaining in contact with the front surface SURF and increase the pressure again once arrived at the positions for the further entries. Unlike with prior art devices, the user does not need to move his finger away from and back to the front surface SURF again and again while inputting a series of entries (e.g., all digits of his PIN code), which may result in less pronounced gestures as with prior art devices. Therefore, it may be difficult for another person to reconstruct the entered PIN code from observing the gestures of the user.

FIG. 10 schematically shows another example of a front view of another exemplary input device. The input device shown in FIG. 10 may relate to a capacitive control panel for an elevator and may hereafter be referred to as elevator control panel.

Such elevator control panel may be an example of an input device comprising a capacitive touch sensor CSENSR comprising a plurality of sense electrodes in a spatial configuration and the capacitive touch sensor controller COON being electrically connected to the plurality of sense electrodes of the capacitive touch sensor CSENSR to obtain a respective plurality of measures of capacitance of the plurality of sense electrodes of the capacitive touch sensor CSENSR. Hereby, positions of touch and press may be detected to discriminate between the different keys of the key pad.

As shown in FIG. 10, the elevator control panel may comprise a touch screen 601. The touch screen 601 may comprise the capacitive touch sensor CSENSR and an electronic display CTDISP′, wherein the electronic display CTDISP' is viewable by the user through the capacitive touch sensor CSENSR′. The electronic display CTDISP may hereby present a plurality of keys to the user, as indicated in FIG. 10 with numerical values ‘−1’-‘3’ to indicate elevator levels and further symbols ‘OPEN’ and ‘CLOSE’. In an example, the input device operates in a sleep mode when the elevator is empty. When a user comes in the elevator and moves his hand within a distance of 5-10 cm of the input device, the elevator control panel wakes up and controls the electronic display CTDISP′ to faintly illuminate.

When a user wishes operates the capacitive touch sensor CSENSR, he may first bring his finger FIN in close proximity to or in contact with the front surface SURF of the capacitive touch sensor CSENSR. The capacitive touch sensor controller COON detects this situation from comparing the measure of capacitance with the first threshold. The capacitive touch sensor controller COON may then signal such contact to the user by, for example, highlighting the displayed key that is closest to the point of contact of the finger. The user may then increase the finger pressure on the highlighted displayed key to input the associated value as a first entry, or, when the user wishes to press another key, move his finger to another position on the front surface SURF, corresponding to the key that the user wishes to press, and then increase the pressure to input the associated value as the first entry. The capacitive touch sensor controller COON detects this latter situation from comparing the measure of capacitance with the second threshold. The capacitive touch sensor controller COON may then signal such pressure to the user by, for example, showing a confirmation message. Compared to prior art touch panels, the chance that an accidental input is detected as a result of an unintentional touching of the front surface may hereby be reduced considerably.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system. The computer program may be provided on a data carrier, such as a CD-rom or diskette, stored with data loadable in a memory of a computer system, the data representing the computer program. The data carrier may further be a data connection, such as a telephone cable or a wireless connection.

In the foregoing specification, the invention has been described with reference to specific examples of embodiments of the invention. It will, however, be evident that various modifications and changes may be made therein without departing from the broader spirit and scope of the invention as set forth in the appended claims. For example, the connections may be any type of connection suitable to transfer signals from or to the respective nodes, units or devices, for example via intermediate devices. Accordingly, unless implied or stated otherwise the connections may for example be direct connections or indirect connections.

Because the apparatus implementing the present invention is, for the most part, composed of electronic components and circuits known to those skilled in the art, circuit details will not be explained in any greater extent than that considered necessary as illustrated above, for the understanding and appreciation of the underlying concepts of the present invention and in order not to obfuscate or distract from the teachings of the present invention.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The term “program,” as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system.

Some of the above embodiments, as applicable, may be implemented using a variety of different information processing systems. For example, although FIG. 1 and the discussion thereof describe an exemplary information processing architecture, this exemplary architecture is presented merely to provide a useful reference in discussing various aspects of the invention. Of course, the description of the architecture has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Also for example, in one embodiment, the illustrated elements of capacitive touch sensor controller COON may be circuitry located on a single integrated circuit or within a same device. Alternatively, capacitive touch sensor controller COON may include any number of separate integrated circuits or separate devices interconnected with each other. For example, a memory may be located on a same integrated circuit as processor PROC and/or display driver DRIV or on a separate integrated circuit or located within another peripheral or slave discretely separate from other elements. Also for example, control unit CON or portions thereof may be soft or code representations of physical circuitry or of logical representations convertible into physical circuitry. As such, control unit CON may be embodied in a hardware description language of any appropriate type.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Also, the invention is not limited to physical devices or units implemented in non-programmable hardware but can also be applied in programmable devices or units able to perform the desired device functions by operating in accordance with suitable program code. Furthermore, the devices may be physically distributed over a number of apparatuses, while functionally operating as a single device. Also, devices functionally forming separate devices may be integrated in a single physical device. For example, the capacitive touch sensor controller COON may be integrated with, or separate from, the capacitive touch sensor CSENSR and/or the display driver DRIV may be integrated with, or separate from, the electronic display CTDISP.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A method of sensing a user input to a capacitive touch sensor having a sense electrode, the method comprising:
obtaining a measure of capacitance of the sense electrode of the capacitive touch sensor (CSENSR),
determining an indication of contact between a finger of a user and the capacitive touch sensor from comparing the measure of capacitance to a first threshold,
determining an indication of exceeding a minimum pressure exercised by the finger of the user on the capacitive touch sensor from comparing the measure of capacitance to a second threshold, the second threshold being different from the first threshold.

2. A method according to claim 1, the method further comprising, if the indication of the pressure corresponds to the pressure exceeding the minimum pressure, providing the user input according to the indication of the pressure.

3. A method according to claim 1, the method further comprising, if the indication of the contact corresponds to the finger making contact, signalling to the user that a contact is detected.

4. A method according to claim 1, the method further comprising, if the indication of the pressure corresponds to the pressure exceeding the minimum pressure, signalling to the user that a push is detected.

5. A method according to claim 1, further comprising dynamically controlling the first threshold and/or the second threshold.

6. A method according to claim 1, further comprising initializing the first threshold and/or the second threshold with a pre-determined first and/or second value.

7. A method according to claim 1, further comprising dynamically determining a baseline level and controlling the first threshold and/or the second threshold in dependence on the baseline level.

8. A method according to claim 1, wherein determining the indication of exceeding a minimum pressure exercised comprises processing the measure of capacitance using a neurophysiologic signal processing.

9. A method according to claim 1, the method further comprising:
determining an indication of a degree of pressure exercised by the finger on the capacitive touch sensor from comparing the measure of capacitance to the first threshold, the second threshold and the at least one further threshold,
wherein providing the user input according to the indication of the pressure comprises providing the user input according to the indication of the degree of pressure.

10. A method according to claim 1, the method further comprising:
determining an indication of a presence of the user at a distance from the capacitive touch sensor from comparing the measure of capacitance to a wakeup threshold, the wakeup threshold being different from the first threshold and the second threshold.

11. A method according to claim 1, the sense electrode comprising a first electrode part and a second electrode part arranged for a differential capacitance measurement, wherein the obtaining the measure of capacitance of the sense electrode of the capacitive touch sensor comprises obtaining a differential capacitance measurement from the first electrode part and the second electrode part.

12. A method according to claim 1, wherein the first threshold corresponds to a first capacitance value, the second threshold corresponds to a second capacitance value, the second capacitance value being at least four times larger than the first capacitance value.

13. A method according to claim 1, the method comprising, after having determined the indication of exceeding the minimum pressure as the indication of the pressure corresponding to the pressure exceeding the minimum pressure:
determining an indication of a sequence of a decrease of the pressure exercised by the finger followed by an increase of the pressure, from comparing the measure of capacitance to a third second threshold to indicate the decrease and subsequently comparing the measure of capacitance to the second threshold to indicate the increase,
the third threshold being in between the first threshold and the second threshold, the third threshold being equal to the first threshold, or the third threshold being equal to the second threshold.

14. A method according to claim 1, further comprising selecting a signal processing mode from a plurality of signal processing modes in dependence on the comparison of the measure of capacitance to the first threshold and/or the comparison of the measure of capacitance to second first threshold.

15. A capacitive touch sensor controller comprising a capacitance detector, the capacitance detector comprising a first terminal for electrically connecting to a sense electrode of a capacitive touch sensor to obtain a measure of capacitance of the sense electrode of the capacitive touch sensor, the capacitive touch sensor controller being arranged to perform a method according to claim 1.

16. An input device for receiving user input, the input device comprising a capacitive touch sensor and a capacitive touch sensor controller according to claim 15, the capacitive touch sensor controller being electrically connected to the sense electrode of the capacitive touch sensor to obtain a measure of capacitance of the sense electrode of the capacitive touch sensor and to provide the user input to the apparatus.

17. An input device according to claim 16, the capacitive touch sensor comprising a plurality of sense electrodes in a spatial configuration and the capacitive touch sensor controller being electrically connected to the plurality of sense electrodes of the capacitive touch sensor to obtain a respective plurality of measures of capacitance of the plurality of sense electrodes of the capacitive touch sensor.

18. An input device according to claim 16, the input device comprising a touch screen, the touch screen comprising the capacitive touch sensor and an electronic display, wherein the electronic display is viewable by the user through the capacitive touch sensor.

19. An apparatus comprising an input device according to claim 16.
